(19) United States
(12) Patent Application Publication
(10) Pub. No.: US 2013/0307670 A1
(43) Pub. Date: Nov. 21, 2013

(54) BIOMETRIC AUTHENTICATION SYSTEM

(71) Applicant: Jonathan E. Ramaci, Isle of Palms, SC (US)

(72) Inventor: Jonathan E. Ramaci, Isle of Palms, SC (US)

(21) Appl. No.: 13/892,635

(22) Filed: May 13, 2013

Related U.S. Application Data
(60) Provisional application No. 61/647,262, filed on May 15, 2012.

(51) Int. Cl. G05B 1/00

(52) U.S. Cl. CPC G05B 1/00
USPC 340/5.82

(57) ABSTRACT

Embodiments of the invention relate to systems, methods, and computer program products for implementing a biometric authentication system. The biometric authentication system receives biometric information for a user, stores the information in a secure memory device, and compares the biometric information to a scan received at a later time to determine if the user has authenticated the user's identity. Once the user's identity is authenticated, the user may gain access to data, such as user data stored on an associated device, or may cause an action to occur. Various actions that may be prompted by authentication are provided, such as facilitating transactions, accessing remote servers, or authenticating the user's identity to third parties.

### BACKGROUND

Individuals currently carry multiple forms of identification with them in order to provide support for the individual's identity. For example, an individual may carry a driver's license, a student ID card, various credit cards, or immigration documents with them. These documents, however, may be lost or stolen. Other people may attempt to forge these documents and represent themselves as the individual. Security issues result in people being constantly vigilant regarding personal identification documents. When an individual loses a wallet or purse, cards must be cancelled, new cards must be applied for, and other identification documents need to be replaced. Individuals may even fear identity theft or fraud.

Further, carrying identification documents is inconvenient. A person may forget their wallet or purse and then have no way to prove the individual's identity. Individuals may not know what type of information will be needed at any time and may not be able to carry that information with them in paper or other formats. For example, an individual may get into an accident but not have the individual's complete medical record with them and so cannot provide medical records to health care providers. The inconvenience of carrying large amounts of data around prevents people from being prepared when that data is needed.

Thus, there is a need for a secure, convenient means for identification that cannot be misplaced or forged by other individuals.

### SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Some embodiments provide a biometric authentication system for identifying a user that includes a memory device, a communication device, and a processing device. The processing device is operatively coupled to the memory device and the communication device and configured to execute computer-readable program code to receive biometric information for a user; store the biometric information in the memory; compare the biometric information to a biometric scan; and authenticate an identity of the user based on the comparison of the biometric information and the biometric scan. In some embodiments the biometric scan is selected from a fingerprint scan, an iris scan, a pupil scan, a facial scan, and an EKG. More than one set of biometric information may be received and the user may customize the different sets of biometric information to cause different actions, such as use of specific payment methods. In some embodiments, the system evaluates the biometric information to determine whether biometric information is diagnostic of the user. In still further embodiments, the biometric system also receives user data, such as financial account information, that is secured by the biometric authentication system. The user data may be encrypted using the biometric information.

In certain embodiments, the system provides access to secure data or causes actions to occur after authentication of the user's identity using the biometric authentication system. For example, the system may provide access to an associated mobile device, the system may provide access to remote servers or computers, or the system may provide access to physical areas, such as lock boxes or secure doors. In a further example, the system records physical activity and/or health records of the user and stored the health data in the secure memory. When the user authenticates the user's identity, the user's health data may be transferred to a health care professional and/or insurance company. Various settings of the associated mobile device may be controlled based on authentication of the user. For example, specific payment methods may be selected, the user may “clock-in” based on the internal clock, positioning system, and authentication system, or the user may turn on or off location-based services associated with mobile devices.

In some embodiments, a computer program product or a computer-implemented method having all of the features described herein is also provided.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram illustrating a process flow for an apparatus for providing a biometric authentication system, in accordance with some embodiments of the invention;

FIG. 2 is a depiction of an environment in which an apparatus provides a biometric authentication system, in accordance with some embodiments of the invention;

FIG. 3 is a block diagram illustrating a mobile device, in accordance with an embodiment of the invention;

FIG. 4 is a block diagram of a biometric authentication system, in accordance with some embodiments of the invention; and

FIGS. 5A and 5B are flow charts of a system for providing a biometric authentication, in accordance with some embodiments of the invention.

### DETAILED DESCRIPTION OF EMBODIMENTS OF THE INVENTION

This provisional application is filed concurrently with related provisional applications titled “SECURE DATA STORAGE AND TRANSACTION SYSTEM”, titled “DYNAMICALLY RE-PROGRAMMABLE TRANSACTION CARD”, titled “VIRTUAL CURRENCY SYSTEM AND APPARATUS”, titled “PAYMENT INITIATION AND ACCEPTANCE SYSTEM”, titled “MAGNETIC STRIP READER”, and titled “SYSTEMS, METHODS AND COMPUTER PROGRAM PRODUCTS FOR THE RECEIPT OF TRANSACTION OFFERS”, which are assigned to the assignee of this application.

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Additionally, while embodiments are disclosed as “comprising” elements, it should be understood that the embodiments may also “consist of” elements or “consist essentially of” elements.

Although embodiments of the present invention described herein are generally described as involving a merchant, it will be understood that merchant may involve one or more persons, organizations, businesses, institutions and/or other entities such as financial institutions, services providers, stores, entities, etc. that implement one or more portions of one or more of the embodiments described and/or contemplated herein.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, apparatus, systems, methods and computer program products are herein disclosed for providing a biometric authentication system. Specific embodiments disclosed herein relate to a biometric authentication system for mobile devices such as mobile phones. In one embodiment, the biometric authentication system is a device that attaches to or associates with the mobile device. In another embodiment, the biometric authentication system is integral with the mobile device. In an embodiment, the biometric authentication system provides access to secure documents and services. In a further embodiment, the biometric authentication system allows actions to occur that are based upon authentication of a user's identity. While specific examples of secure access and actions are provided herein, one skilled in the art given the guidance in this specification would not be limited to the exemplary embodiments.

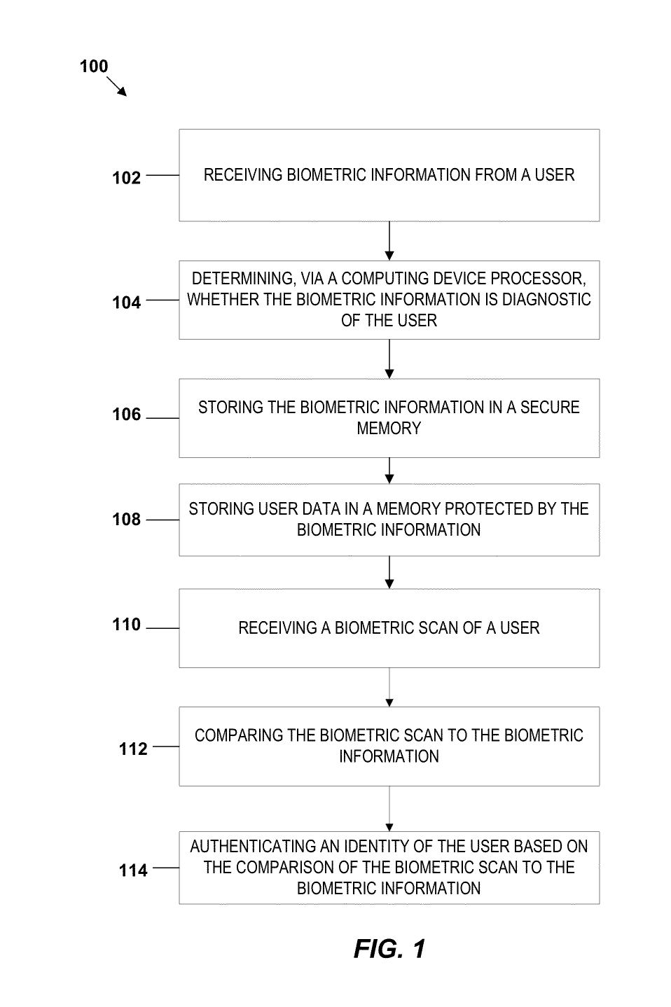

FIG.1 illustrates a general process flow 100 for an apparatus or system for providing a biometric authentication system consistent with an embodiment of the present invention. As shown in block 102, the system receives biometric information from a user. In some embodiments, the system receives the biometric information from a biometric scanner. For example, a fingerprint scanner may be associated with the biometric authentication system. In some embodiments, the fingerprint scanner may be a UPEK® TouchStrip® fingerprint sensor (TCD5-TCS4) and matching processor. A user of the biometric authentication system swipes a finger of the user on the fingerprint scanner to provide the biometric information to the system. The fingerprint sensor includes CMOS active capacitance pixel sensing with anti-spoofing capabilities. In an embodiment, the fingerprint sensor also includes a conductance sensor to determine that the finger has a conductance, so that the fingerprint sensor can determine that the user is alive.

In some embodiments, the biometric scanner is configured to receive other types of biometric information from the user. In an embodiment, a camera associated with the biometric authentication system receives iris, retina, or facial scans. In an embodiment, each of these scans may be used to authenticate an individual's identity. The camera may be a camera associated with the mobile device or a camera attached to a biometric authentication system. In an embodiment, software compares features in the iris, retina, or facial scan with biometric information provided by the user.

In further embodiments, other types of biometric scanners may be used. For example, heartbeat and/or EKG sensors may be used to identify an individual. A device may capture a feature of a heartbeat or an EKG signature for an individual and compare biometric scans to the biometric information provided by the user. Similarly, DNA fingerprinting or fluid analysis may be integrated into the biometric authentication system. Saliva, blood, tears, or cells (e.g., cells swabbed from the inside of the mouth) may be used to securely identify an individual using the biometric authentication system. A microphone may capture a voice recording of an individual and compare the voice recording to biometric information associated with the user's voice.

In some embodiments, the user provides more than one set of biometric information. For example, the user may scan each finger so that the biometric authentication system includes ten different sets of biometric information for the user. In an embodiment, the user may assign different tasks to each set of biometric information or finger. For example, the right index finger may provide access to an associated mobile device. The right middle finger may shut down the associated mobile device's location tracking functionality. In this manner, the user can quickly and easily toggle on and off tracking by mobile devices. In an exemplary embodiment, each set of authentication information can be assigned to a different payment method. For example, when the biometric authentication system is used to facilitate payments, either through a rewritable card, through biometric signatures for transactions, or through wireless transfers, each set of biometric information may cause a different payment method (e.g., credit card A, credit card B, gift card, checking account, etc.) to be used for the payment. In another embodiment, different types of biometric information may also be stored in the biometric authentication system and used for different purposes. For example, fingerprints may be stored for general access to the mobile device and determining payment vehicles, while iris scans may be stored in the biometric authentication system for accessing a specific application on the mobile device. It should be understood that the flexibility afforded by the biometric authentication system allows customized control of associated mobile devices by allowing the user to define the action or actions that will result based on authentication using a specific set of biometric information.

In still further embodiments, the system receives the biometric information from a secondary source. For example, the system may receive fingerprint information from a government agency. In some embodiments, a user's fingerprints and/or other biometric information is recorded at a central location and provided to the biometric authentication system. For example, in some situations an employer or governmental agency may capture a user's biometric information at one point in time and provide the biometric information to the system at a later point in time. Health care providers, schools, businesses, or non-profit organizations may also capture a user's biometric information and provide it to the biometric authentication system.

In block 104, the system determines whether the biometric information is diagnostic for the user. In some embodiments, the system determines whether the biometric information is of sufficient detail to securely identify the user. For example, the system may determine if a fingerprint includes detailed whorls and ridges to identify a user with at least a minimum confidence level. In some embodiments, the biometric information is of sufficient detail to identify an individual when the system is able to identify a minimum number of features that characterize an individual. In an embodiment, multiple scans from the user may be used to build a composite of biometric information for the user, which can then be used to authenticate the user's identity.

In some embodiments, the system determines that the biometric information is not diagnostic for the individual; that is, the system determines that the biometric information does not include sufficient detail to securely identify an individual. In these embodiments, the system prompts the user to re-enter the user's biometric information. For example, the system may prompt the user to re-scan the user's fingerprint or iris during an account set-up process. The system may prompt the user to enter different biometric information of a specific type (e.g., scan a different finger or a different eye) or the system may prompt the user to use a different type of biometric information entirely (e.g., change from scanning fingerprint to scanning irises).

In block 106, once it has been determined that the biometric information is diagnostic of the user, the biometric information is stored in a memory device. In an embodiment, the biometric information is stored in a secure memory device and used to provide access to secure data and/or to authenticate the user's identity. In some embodiments, the biometric information is stored in an on-chip EEPROM under DES encryption. In some embodiments, DES, AES, and SHA-1 cryptography use unreadable secrets to prevent unauthorized access and forgery.

As shown in block 108, in some embodiments, user data is also stored in a memory device. User data includes payment information (e.g., credit card, account numbers, etc.), personal information (e.g., loyalty cards, health records, access codes, pictures, etc.), and/or business information (e.g., documents, records, etc.). In some embodiments, the user data is stored in the same memory device as the biometric information. In another embodiment, the user data is stored in a different memory device than the biometric information. For example, the user data may be stored in a remote server that is only accessible by the system after authenticating an identity using the biometric information. The user data may also be encrypted using any or all of the encryption techniques described herein.

In a further embodiment, the biometric information is used to encrypt the user data. For example, an algorithm based on some metric derived from the biometric information may be used to encode the user data. In one embodiment, measurements associated with the biometric information are converted via an algorithm into an encryption technique or key. The encryption key is then used to encode the user data so that only the user with the same key, i.e., the user's biometric information. When the user attempts to access the user data via the biometric authentication system, the user's biometric scan can be used to recreate the encryption key from the user's biometric data and decode the user data. In this manner, only the user can access the user data. If another user attempted to decode the user data, the different user's biometric data would not result in a decryption algorithm that provides legible data. The user's biometric information is a personalized key that encodes and/or decodes data such that only the user can access the data.

Turning now to block 110, in some embodiments the system receives a biometric scan of a user. For example, a user may desire to access secure information stored in associated with the biometric authentication system or the user may desire to authenticate the user's identity. In these scenarios, the user activates the biometric scanner associated with the biometric authentication system and the system receives a biometric scan from the user.

In block 112, the system compares the biometric scan to the biometric information. In an embodiment, the system includes biometric information for only one user. If the comparison indicates that the biometric scan and the biometric information are not a match, then the user's identity is not authenticated. In an embodiment, the biometric authentication system may have biometric information stored for more than one user. For example, the biometric information system may store biometric information for every member of a family or multiple employees of a business. In this manner, the biometric authentication system may provide functionality to more than one user. In an embodiment, once authorized all users have the same access and user rights. In another embodiment, each user may have personal biometric information and once authorized gain access to personalized user data stored in the biometric authentication system. In a still further embodiment, access to the mobile device includes multiple tiers. Users may have low-level access to the mobile device, without authenticating the user's identity, but access to secure areas may require authentication.

In some embodiments, a secondary confirmation is used in addition to the biometric scan to authenticate the user's identity. In an embodiment, the system requires a password or code to be entered by the user before authenticating the user's identity. In a still further embodiment, the system completes a check to determine whether hardware codes (e.g., component IDs) are correct. In this embodiment, the system records component IDs for hardware associated with the biometric authentication system upon activation and confirms that the system has not been tampered with by checking these component IDs. If a component ID is incorrect or different from the biometric authentication system records, the system may refuse to authenticate the user's identity. In an embodiment, differing component IDs may indicate that hardware is being used in an attempt to improperly gain access to the user data. In some embodiments, as discussed, the system also includes a conductance or other “liveness” sensor to determine that the biometric scan came from an individual that is alive. For example, the conductance sensor may be used to identify the natural conductance in human skin from a fingerprint scan. A dilation test may be used when evaluating iris or retina scans. In a still further embodiment, the system requires an audio or video recording to allow access. For example, a voice print may need to match a voice recording on record. A word or phrase may need to be spoken in order to provide access. The word or phrase may change frequently. In an embodiment, a positioning system device associated with the biometric authentication system may be used to detect a specific gesture made with the system in order to allow access or authenticate the user's identity.

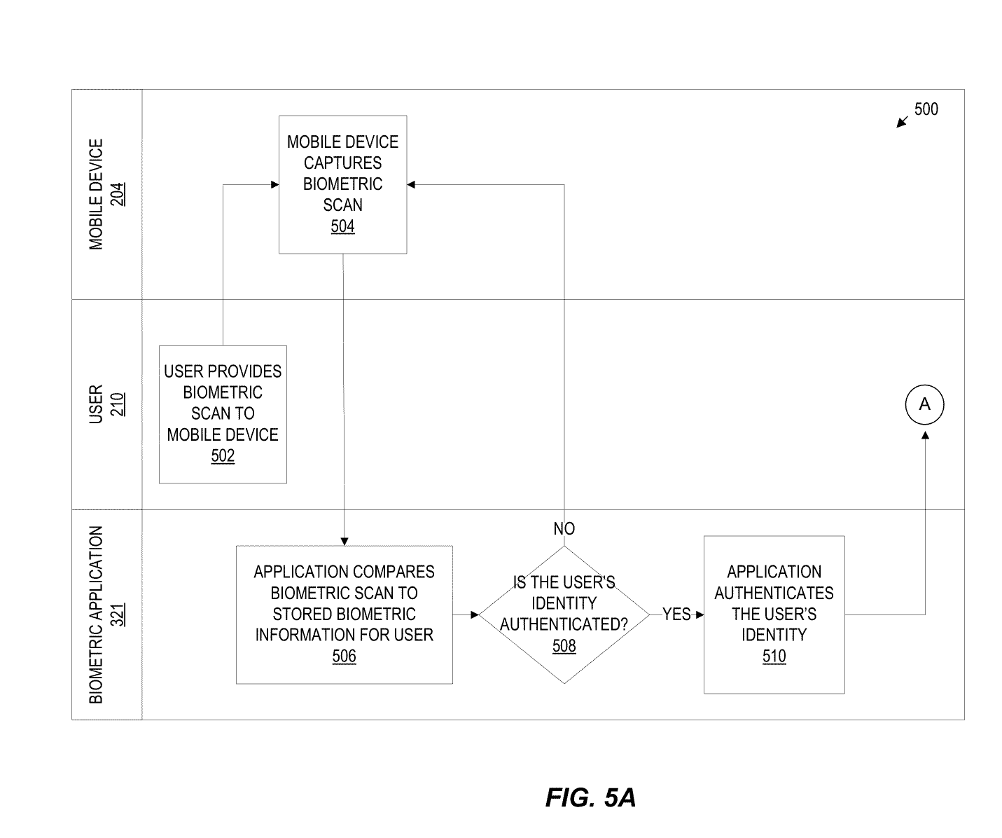

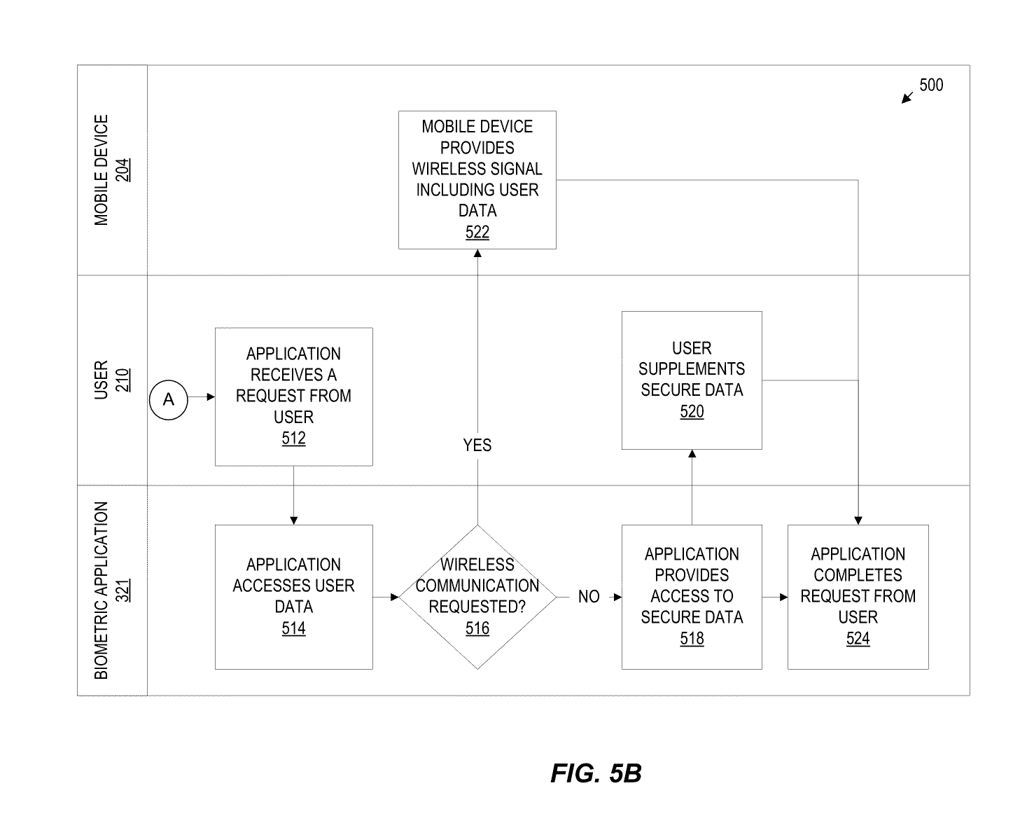

Finally, in block 114, the system authenticates the identity of the user based on the comparison of the biometric scan to the biometric information. In an embodiment, based on the comparison between the biometric scan and the biometric information, the system may authenticate the user's identity. In an embodiment, the user is identified based on a statistical similarity test. For example, the user is authenticated if the biometric scan and the biometric information are 95% similar. The level of similarity may be adjusted to account for variation in biometric scanner resolution, desired level of confidence, or any other feature. For example, the level of similarity may be set to 90%, 99%, or 99.9%. Once authenticated, the user may gain access to the system and/or the mobile device. As will be discussed in greater detail in FIG. 5, the user will be able to access secure areas of the biometric authentication system and perform actions that are based on authentication of the user's identity. For example, the user may be able to biometrically sign a transaction or legal document using the biometric authentication system. In this example, the biometric signature would supplement and/or replace a written signature. Other examples will be discussed and it should be understood that these examples are merely exemplary and one skilled in the art would be able to use the biometric authentication system in other ways.

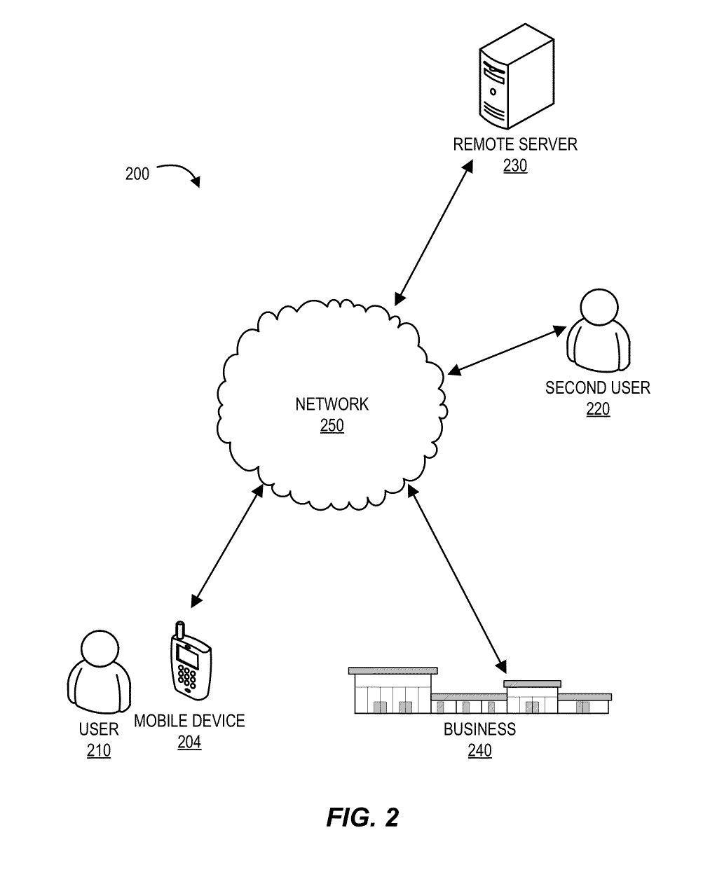

Referring to FIG. 2, a block diagram illustrating an environment 200 in which a biometric authentication system associated with a mobile device of a user authenticates the user's identity to allow access to secure storage and performance of actions based on authentication of the user's identity. The system determines that the user 210 is completing a biometric scan using, in some embodiments, the mobile device 204. As discussed herein, the biometric authentication system authenticates the user's identity based on a comparison of the biometric scan to biometric information stored in association with the biometric authentication system. In some embodiments, after authenticating the user's identity, the system provides access to secure information of the user. For example, the user may be able to access secure settings and/or data on the mobile device.

As shown in FIG. 2, the mobile device and the biometric authentication system communicate with one another and in some embodiments with other users 220, remote servers 230, and businesses 240 over a network 250, which may include one or more separate networks. In addition, the network 250 may include a local area network (LAN), a wide area network (WAN), and/or a global area network (GAN), such as the Internet. It will also be understood that the network 250 may be secure and/or unsecure and may also include wireless and/or wireline technology.

In some embodiments, after authenticating the user's identity, the system causes an action to occur by transmitting information. For example, the system may facilitate a transaction at a business 240 by biometrically signing or authorizing a transaction. The system may also transfer access codes to vehicles or doors. In a still further embodiment, the system responds to an identification request by prompting the user to authenticate the user's identity. In response, a third party, such as users 220 or remote servers 230, may provide information or benefits to the user. In some embodiments, the user 210 is identified in coordination with a secondary confirmation process. For example, the system may confirm that components of the authentication device include the originally-registered component IDs.

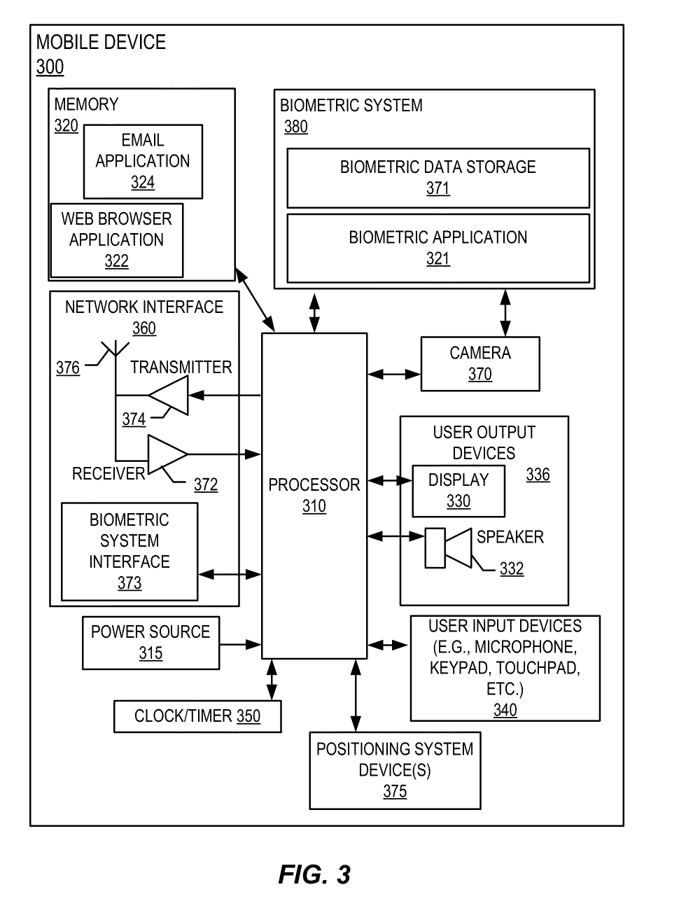

FIG. 3 illustrates an embodiment of a mobile device 300 that may be configured with the biometric authentication system. A “mobile device” 300 may be any mobile communication device, such as a cellular telecommunications device (i.e., a cell phone or mobile phone), personal digital assistant (PDA), smartphone, a mobile Internet accessing device, or other mobile device including, but not limited to portable digital assistants (PDAs), pagers, mobile televisions, gaming devices, laptop computers, tablet computers, cameras, video recorders, audio/video players, radios, GPS devices, and any combination of the aforementioned, or the like. In some embodiments, the mobile device 300 includes a wired or wireless connection to a transaction apparatus, wherein the transaction device is configured to provide biometric authentication functionality. The transaction apparatus as described herein may be, in some embodiments, associated with the mobile device, such as being a case or attachment for a mobile device. In other embodiments, the transaction apparatus may be a standalone device. The transaction apparatus comprises at least a processor and memory device for receiving, storing, encrypting, accessing, transferring, and/or presenting data including, but not limited to financial data, authentication data, identification data, personal data, and/or other data associated with a user.

In some embodiments, the transaction apparatus may receive data by communication with the mobile device, a detachable magnetic card reader, photography, accessing the Internet via a network, biometric reader, manual input by a user, and the like. The communication with the mobile device may be through a direct hardwire connection or network connection such as NFC, Bluetooth®, Bluetooth® lite, etc. The detachable magnetic card reader may attach to the transaction apparatus, the mobile device, or another device in communication with the transaction apparatus or mobile device. The attachment may, in some embodiments be though a hardwire connection such as through a USB port, micro-USB port, microphone port, etc. or a network connection.

In some embodiments, the data received may then be stored within the transaction apparatus. In some embodiments, the data may be stored in the transaction apparatus such that a mobile device or other device associated with the transaction apparatus may not have access to the data stored within the transaction apparatus. In some embodiments, the data may be stored in the transaction apparatus such that a mobile device or other device associated with the transaction apparatus may have limited access to the data stored within the transaction apparatus. The data stored within the transaction apparatus may be encrypted such that unwanted attempts to access the data may be denied.

In some embodiments, a user of the transaction apparatus may access the data stored within the transaction apparatus. Prior to allowing access to all of the financial, identification, and/or personal data that is stored within the transaction apparatus, the user may be required to present authorization data to the transaction apparatus to ensure the user is authorized to access the data. The authorization data may be presented by the user to the mobile device or the transaction apparatus. The authorization data may include biometric scanning, such as finger print scanning, retinal scanning, etc., Personal Identification Number (PIN) authorization, shape or object selectment authorization, and the like. The authorization, if accepted, may allow a user to utilize the data stored within the transaction apparatus. However, the data may only be utilized for specific tasks, as such, typically some and/or all of the data may not be communicated from transaction apparatus to the mobile device.

The user may access and view portions of the data via the mobile device display utilizing an application or other program associated with the transaction apparatus. For example, if a user provided a credit card to the transaction apparatus, the user may be presented with a representation of that credit card via the application. The representation may include information that would be found on a typical credit card, such as an account number, name associated with the account, type of card, etc. However, the transaction apparatus may have also stored the information associated with the magnetic strip on the credit card. This information may not be presented to the user via his/her mobile device. In this way, certain information may be stored within the transaction apparatus and not communicated to a mobile device of the like.

Accessing and viewing a representation of the data stored within the transaction apparatus on a display allows a user to select the financial, identification, and/or personal data that the user may wish to use during a transaction. For example, the user may have multiple credit cards and debit cards that he/she may select from when purchasing a product from a merchant. The user may selection the one or more credit or debit cards that he/she may wish to use for this transaction.

Once the user selects the data from the display, the mobile device may present the selection to the transaction apparatus. The transaction apparatus will determine what data is stored in association with the user's selection and transfer that data to an output device.

In some embodiments, the transaction apparatus may present the selected data via an output device associated with the transaction apparatus. In this way, the output device may receive all data stored in the transaction apparatus associated with the selected financial account, identification, or the like. Output devices may include, but are not limited to a writable transaction card, E-ink display, and/or the like. In one example, the user may select financial account data associated with a debit card. The transaction apparatus may access the stored data associated with the debit card, such as, but not limited to the card account number, security number, name associated with the account, expiration date, all data stored on the magnetic strip, etc. The transaction apparatus may then communicate that data to the writable transaction card associated with the transaction apparatus. As such, the writable transaction card may now be utilized as the debit card by the user for payments at a merchant, ATM, bank, etc. In this way, the writable transaction card associated with the transaction device may be used by the user as the debit card. In another example, the user may select loyalty account data associated with a merchant. The loyalty account data may have been inputted from a photograph of a barcode and number associated with the loyalty account. The transaction apparatus may then build a graphic of the bar code and store the bar code in association with that loyalty account. Upon selection of the loyalty account data, the transaction apparatus may access the bar code information, merchant associated with the loyalty account, loyalty account number, etc. The transaction apparatus may then communicate that data to an E-ink display associated with the transaction apparatus. The user may utilize the bar code on the E-ink display as his/her loyalty account.

Upon completion of a user utilizing the data for a transaction via an output device the transaction apparatus may time-out the output device. In this way, the data may be erased from the output device to prevent misuse of the data.

The mobile device 300 may also generally include a processor 310 communicably coupled to such components as a memory 320, user output devices 336, user input devices 340, a network interface 360, a power source 315, a clock or other timer 350, a camera 370, at least one positioning system device 375, one or more biometric systems 380, etc. The processor 310, and other processors described herein, may generally include circuitry for implementing communication and/or logic functions of the mobile device 300. For example, the processor 310 may include a digital signal processor device, a microprocessor device, and various analog to digital converters, digital to analog converters, and/or other support circuits. Control and signal processing functions of the mobile device 300 may be allocated between these devices according to their respective capabilities. The processor 310 thus may also include the functionality to encode and interleave messages and data prior to modulation and transmission. The processor 310 may additionally include an internal data modem. Further, the processor 310 may include functionality to operate one or more software programs or applications, which may be stored in the memory 320. For example, the processor 310 may be capable of operating a connectivity program, such as a web browser application 322. The web browser application 322 may then allow the mobile device 300 to transmit and receive web content, such as, for example, location-based content and/or other web page content, according to a Wireless Application Protocol (WAP), Hypertext Transfer Protocol (HTTP), and/or the like.

In some embodiments, the positioning system device 375 is configured to determine the location of the mobile device. For example, at least one of the position system devices 375 may interact with the transceiver to send and/or receive information with wireless transmitters, such as GPS or Wi-Fi. In further embodiments, the positioning system device 375 is configured to determine movement and/or orientation of the mobile device. Accelerometers, magnetometers, and other devices can be included in the mobile device to provide information to the device on the location and velocity (speed and direction) of the device. Other types of positioning system devices 375 may be included in the device without limitation. For example, altimeters can be included in the device to determine the elevation of the device. Similarly, electronic or standard compasses may be included. In an embodiment, the positioning system device 375 may be used in coordination with the biometric authentication system to capture health data relating to the user. In an embodiment, the user's movement is tracked so that it can be stored and transferred. Activity levels, calories burned, sleep patterns, and instantaneous health recordings (e.g., blood pressure, eye dilation, skin conductance, glucose levels, EEG, EKG, etc.) can be recorded by the biometric authentication system or by a device linked to the biometric authentication system (e.g., a glucose monitor, etc.). The health records can then be encrypted with the biometric information for secure storage and use. In an embodiment, prescriptions, over-the-counter drugs, portions of genomic data, MRI's, x-rays, etc., may also be stored by the biometric authentication system. In a still further embodiment, the biometric authentication system tracks and stores the user's health data and triggers alarms if the health data deviates from predetermined thresholds. For example, if the blood pressure rises above a predetermined level or falls below a predetermined level, then an alarm may sound, an email may be sent to the user or another individual (e.g., parent or health professional), or some other action may be taken by the biometric authentication device to alert the user and/or control the condition.

The processor 310 may also be capable of operating applications, such as a biometric application 321. The biometric application 321 may be downloaded from a server and stored in the memory 320 of the mobile device 300. Alternatively, the biometric application 321 may be pre-installed and stored in a memory of the biometric system 380 or activated directly from a website operably linked to the mobile device 300 through the network interface 360. In embodiments where the biometric application 321 is pre-installed or run from a website, the user may not download the biometric application 321 from a server.

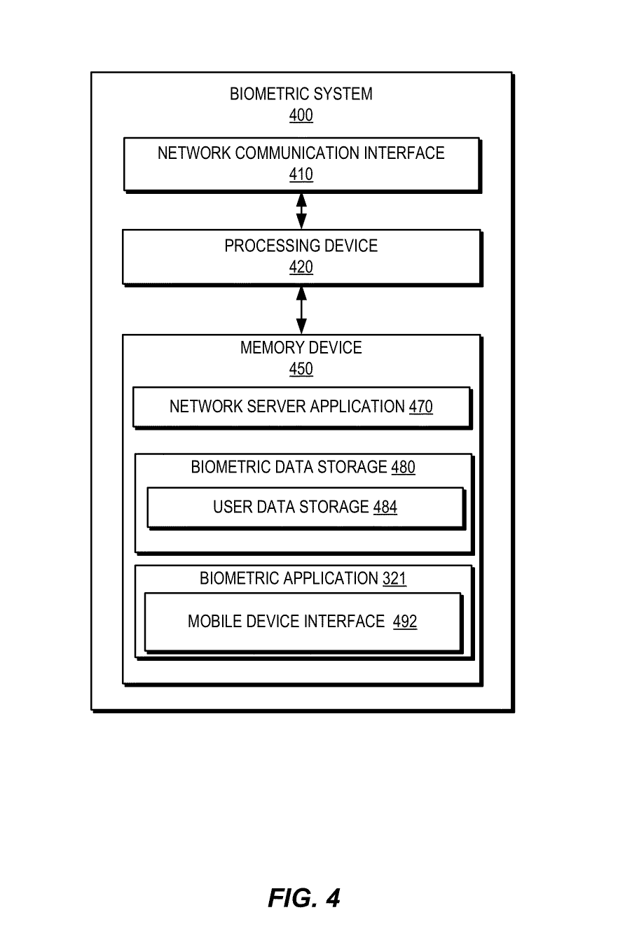

The biometric system 380, as will be discussed in greater detail in FIG. 4, may include the necessary circuitry to provide the biometric authentication functionality to the mobile device 300. Generally, the biometric system 380 will include biometric data storage 371, i.e., a database, which may include data associated with biometric information as well as user data. The biometric system 380 and/or biometric data storage 371 may be an integrated circuit, a microprocessor, a system-on-a-chip, a microcontroller, or the like. As discussed above, in one embodiment, the biometric system 380 provides the biometric authentication functionality to the mobile device 300.

Of note, while FIG. 3 illustrates the biometric system 380 as a separate and distinct element associated with the mobile device 300, it will be apparent to those skilled in the art that the biometric system 380 functionality may be incorporated within other elements in the mobile device 300. For instance, the functionality of the biometric system 380 may be incorporated within the mobile device memory 320 and/or the processor 310. In a particular embodiment, the functionality of the biometric system 380 is incorporated in an element within the mobile device 300 that provides biometric authentication capabilities to the mobile device 300. Moreover, the functionality may be part of the firmware of the mobile device 300. In some embodiments, the functionality is part of an application downloaded and installed on the mobile device 300. Still further, the biometric system 380 functionality may be included in a removable storage device such as an SD card or the like.

The processor 310 may be configured to use the network interface 360 to communicate with one or more other devices on a network. In this regard, the network interface 360 may include an antenna 376 operatively coupled to a transmitter 374 and a receiver 372 (together a “transceiver”). The processor 310 may be configured to provide signals to and receive signals from the transmitter 374 and receiver 372, respectively. The signals may include signaling information in accordance with the air interface standard of the applicable cellular system of the wireless telephone network that may be part of the network. In this regard, the mobile device 300 may be configured to operate with one or more air interface standards, communication protocols, modulation types, and access types. By way of illustration, the mobile device 300 may be configured to operate in accordance with any of a number of first, second, third, and/or fourth-generation communication protocols and/or the like. For example, the mobile device 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 300 may also be configured to operate in accordance with non-cellular communication mechanisms, such as via a wireless local area network (WLAN) or other communication/data networks.

The network interface 360 may also include a biometric system interface 373 in order to allow a user to execute some or all of the above-described processes with respect to the biometric application 321 and/or the biometric system 380. The biometric system interface 373 may have access to the hardware, e.g., the transceiver, and software previously described with respect to the network interface 360. Furthermore, the biometric system interface 373 may have the ability to connect to and communicate with an external biometric system 380, such as a system that attaches to or wirelessly communicates with the mobile device 300.

As described above, the mobile device 300 may have a user interface that includes user output devices 336 and/or user input devices 340. The user output devices 336 may include a display 330 (e.g., a liquid crystal display (LCD) or the like) and a speaker 332 or other audio device, which are operatively coupled to the processor 310. In another embodiment, eyewear may provide output to the user. The user input devices 340, which may allow the mobile device 300 to receive data from a user 210, may include any of a number of devices allowing the mobile device 300 to receive data from a user 210, such as a keypad, keyboard, touch-screen, touchpad, microphone, mouse, joystick, stylus, other pointer device, button, soft key, and/or other input device(s).

The mobile device 300 may further include a power source 315. Generally, the power source 315 is a device that supplies electrical energy to an electrical load. In one embodiment, power source 315 may convert a form of energy such as solar energy, chemical energy, mechanical energy, etc. to electrical energy. Generally, the power source 315 in the mobile device 300 may be a battery, such as a lithium battery, a nickel-metal hydride battery, or the like, that is used for powering various circuits, e.g., the transceiver circuit, and other devices that are used to operate the mobile device 300. Alternatively, the power source 315 may be a power adapter that can connect a power supply from a power outlet to the mobile device 300. In such embodiments, a power adapter may be classified as a power source “in” the mobile device.

The mobile device 300 may also include the memory 320 operatively coupled to the processor 310. As used herein, memory may include any computer readable medium configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory may additionally or alternatively include an electrically erasable programmable read-only memory (EEPROM), flash memory or the like.

The memory 320 may store any of a number of applications or programs, which comprise computer-executable instructions/code executed by the processor 310 to implement the functions of the mobile device 300 described herein. For example, the memory 320 may include such applications as a biometric application 321, a web browser application 322, an SMS application, an email application 324, etc.

FIG. 4 provides a block diagram illustrating the biometric system 400 in greater detail, in accordance with embodiments of the invention. As illustrated in FIG. 4, in one embodiment of the invention, the biometric system 400 includes a processing device 420 operatively coupled to a network communication interface 410 and a memory device 450.

It should be understood that the memory device 450 may include one or more databases or other data structures/repositories. The memory device 450 also includes computer-executable program code that instructs the processing device 420 to operate the network communication interface 410 to perform certain communication functions of the biometric system 400 described herein. For example, in one embodiment of the biometric system 400, the memory device 450 includes, but is not limited to, a network server application 470, a biometric data storage 480, which includes user data storage 484, a biometric application 321, which includes a mobile device interface 492, and other computer-executable instructions or other data. The computer-executable program code of the network server application 470 or the biometric application 321 may instruct the processing device 420 to perform certain logic, data-processing, and data-storing functions of the biometric system 400 described herein, as well as communication functions of the biometric system 400, such as communication with a mobile device and/or a wireless server.

In some embodiments, the biometric application 321 is the same application as located on the mobile device. In other embodiments, some functionality is present in the biometric system 400 and some functionality is present in the mobile device. As should be understood, the software and hardware providing the biometric authentication functionality can be entirely present on the mobile device, entirely present on the biometric system 400, or divided in some manner between the mobile device and the biometric system 400. In further embodiments, the biometric system also contributes to the biometric functionality by augmenting data and/or processing power of the biometric application(s) 321.

In further embodiments, the mobile device interface 492 facilitates communication between the mobile device and the biometric system 400. For example, the mobile device interface 492 may establish a connection with the mobile device, may encrypt or decrypt communications with the mobile device, or may provide a portal for the user to interact with the biometric application 321 through the mobile device.

As used herein, a “communication interface” generally includes a modem, server, transceiver, and/or other device for communicating with other devices on a network, and/or a user interface for communicating with one or more users. Referring again to FIG. 4, the network communication interface 410 is a communication interface having one or more communication devices configured to communicate with one or more other devices on the network 250, such as the mobile device 300, the biometric system 400, and remote servers. The processing device 420 is configured to use the network communication interface 410 to transmit and/or receive data and/or commands to and/or from the other devices connected to the network 250.

FIG. 5 is a process flow 500 illustrating a process flow for implementing a biometric authentication system, in accordance with embodiments of the invention. FIG. 5 depicts some of the user options and actions that can be taken after the user has authenticated the user's identity through the biometric authentication system. In an embodiment, the biometric authentication system allows secure access to user data and allows an action to be taken that is based on authenticating the user's identity. It should be understood that the access and actions described herein are examples and that one skilled in the art could envision other possibilities for use of the biometric authentication system as described herein.

Turning now to block 502, in some embodiments the user provides a biometric scan to the mobile device. As discussed, providing a biometric scan may include using a biometric scanner associated with the biometric authentication system to capture some measurement of biological data of the user. The biometric scanner may scan a fingerprint, iris, etc. In one embodiment, the biometric scanner is not physically attached to the mobile device. For example, a fingerprint scanner may be integral with an automobile or building door. The user may provide a fingerprint scan to the scanner integral with the car door, which then wirelessly communicates with other components of the biometric authentication system to authenticate the user's identity.

In block 504, in some embodiments the mobile device receives the biometric scan. In some embodiments, the mobile device stores the user data, provides access to the user data, or wirelessly transmits information after authenticating the user's identity. Before performing these tasks, however, the mobile device receives the biometric scan. In some embodiments, the mobile device includes the biometric scanner integral in the device. In other embodiments, the mobile device is connected to the biometric scanner such as being part of a case that carries at least a portion of the mobile device.

In block 506, the biometric application compares the biometric scan to biometric information stored in biometric authentication system. In an embodiment, the biometric authentication system may have biometric information stored for more than one user. For example, the biometric information system may store biometric information for every member of a family or multiple employees of a business. In this manner, the biometric authentication system may provide functionality to more than one user. In an embodiment, once authorized all users have the same access and user rights. In another embodiment, each user may have personal biometric information and once authorized gain access to personalized user data stored in the biometric authentication system.

In block 508, the system determines whether the user's identity is authenticated. In an embodiment, determining whether the user's identity is authenticated comprises comparing to biometric scan to the biometric information and determining whether a user can be identified with a predetermined degree of confidence. In an embodiment, the user is identified based on a statistical similarity test. For example, the user is authenticated if the biometric scan and the biometric information are 95% similar. The level of similarity may be adjusted to account for variation in biometric scanner resolution, desired level of confidence, or any other feature. For example, the level of similarity may be set to 90%, 99%, or 99.9%.

If the user's identity is not authenticated, in some embodiments the application prompts the user to re-enter the user's biometric scan. For example, if a user blinked during an iris scan, the biometric scan may be insufficient to authenticate the user's identity. By prompting the user to re-enter the user's biometric scan, the user has a second chance of authenticating the user's identity. In some embodiments, the system allows a limited number of chances for authenticating an identity before locking and/or wiping the system to protect data integrity.

In block 510, when the user's identity is authenticated the application allows user access to the mobile device and/or biometric authentication system. In an embodiment, graphical user interfaces (GUIs) are provided to assist the user in using the mobile device and/or the biometric authentication system. In a still further embodiment, the biometric authentication system is an access-control device for a commercial device. For example, the biometric authentication system may provide access control for commercially available mobile devices. In some embodiments, the biometric authentication system is controlled at least in part via voice command.

In block 512, in some embodiments the user provides a request to the mobile device and/or the biometric authentication system. The request may relate to access to secure data on the mobile device or stored in association with the biometric authentication system (e.g., stored in a remote server and accessible over a wireless network). In an embodiment, the request defines the actions that will be taken by the mobile device and/or the biometric authentication system. For example, the user may request that medical records be transferred to a medical provider. In an embodiment, primary medical records (e.g., allergies, current medications, etc.) may be stored locally on the mobile device and secondary records (e.g., medical history, etc.) may be stored remotely. After authenticating the user's identity and requesting that medical records be transferred to the medical facility, the mobile device may wirelessly transmit the medical records so that the user has convenient access and ability to securely share important information.

In some embodiments (not shown), the user is prompted to authenticate the user's identity. For example, in some embodiments, a third party, such as an insurance agency, government agency, or the like, may prompt the user to authenticate the user's identity in order to receive information, benefits, payments, etc. In an embodiment, the third party wirelessly communicates with the mobile device and/or the biometric authentication system to prompt the user to authenticate the user's identity. In an embodiment, the authentication serves to clock a person into a business or site. Regular, on-demand, or predetermined time points may be evaluated to determine if a user is present at a facility based on authentication of the individual's identity.

In block 514, the application accesses the user data. In an embodiment, many types of data may be stored by the user. Media data, access data, e-documents, or personal data may be stored by the biometric authentication system. The data may be stored locally or remotely (e.g., in the cloud or remote server). In an embodiment, the user data is encrypted by an additional encryption technique in addition to the biometric authentication. The system may decrypt the user data when the application accesses the user data.

In block 516, in some embodiments the system determines whether wireless communication is requested or will be used to accomplish the user request. For example, the biometric system or the mobile device will wirelessly communicate with another party and/or device when the user desires to cause an action to occur. In an embodiment, the application activates a wireless transmitter when the request entails wireless communication.

In block 518, if wireless communication is not required then the application provides access to the secure data. In an embodiment, the application displays data on a screen associated with the biometric system, e.g., a scene on a mobile device. In some embodiments, the secure data is stored in a digital wallet. For example, the user may be able to access financial records stored in the digital wallet. Similarly, health records, photographs, personal documents, may be accessed and reviewed. In one embodiment, a digital lockbox or inbox is made accessible upon authenticating a user's identity using the biometric system.

In some embodiments, authentication allows access to secure communication devices. For example, after authentication, the user is able to make a secure phone call, send a secure email, conduct a secure video or text chat, or send a secure text message. In some embodiments, authentication of a user's identity will result in a digital signature of the communication so that the recipient of the communication is able to confirm the sender of the communication.

In a still further embodiment, authentication allows access to location services. For example, after authenticating a user's identity the biometric authentication system may allow for credentialing of the user where identity and location are relevant. In one example, the biometric authentication system may authenticate a user's identity for a traveler identity program, such as the Trusted Traveler program for the U.S. Customs and Border Protection department. The user's identity may be authenticated and the user's location may be confirmed when boarding airplanes or other restricted access sites. In this manner, the biometric authentication program serves as a credentialing service that confirms the user is part of a group, e.g., a traveler in a Trusted Traveler program. The user may then receive accelerated review of documents or luggage, or be able to access expedited lines at the facility. In some embodiments, the biometric authentication system coordinates with ticketing procedure to evaluate the user's identity, the user's location, and an external source indicating where the user should be located based on the user's ticket to add an additional level of security to restricted access sites.

In block 520, in some embodiments the user supplements the user data stored in the biometric authentication system. For example, after accessing the user data via the biometric authentication system, the user may input specific data into the associated mobile device. In one example, the user may authenticate the user's identity using the biometric authentication system in order to biometrically sign a bill at a restaurant. The user may also supplement the transfer of financial account information with a tip amount. In this manner, the user's bill is paid based in biometrically authorizing a transaction while also allowing control of supplemental information, e.g., tip amount. Users may supplement the user data stored via the biometric authentication system in any way.

In block 522, when wireless communication will be used to fulfill the user request, then the mobile device provides a wireless signal including user data. The wireless signal may be wi-fi, NFC, Bluetooth, infrared, a LAN, a WAN, a GAN, wireless, or some other communication method. It should be understood that communication can also occur via device. For example, the e-ink display on the card associated with the transaction device may display a bar code or other authentication code. The biometric authentication device may cause the screen of an associated mobile device to display authentication information (e.g., bar codes, QR codes, authentication codes, etc.), which is then scanned or reviewed.

In an embodiment, the biometric authentication system is used to facilitate a transaction, such as a financial transaction. The system may include the ability to validate any transaction where one needs to verify one's identity. For example, peer-to-peer transactions, one touch payment for NFC-enabled devices, wire transfers, card not present transactions, brokerage transactions, money movements, account transfers, etc. In another embodiment, the biometric authentication system enables virtual payment, such as in computer or video-gaming currencies, by wirelessly connecting to the receiving platform (e.g., video game console) and transferring the virtual or valid currency. In one embodiment, the system facilitates transaction by writing account information onto a re-writable card associated with the biometric authentication system. As previously discussed, each finger may be associated with a different payment method. When the user scans a particular finger, a pre-defined payment method may be activated (e.g., wireless transferred, written onto the re-writable card, displayed as a barcode on the associated mobile device, etc.).

In a further embodiment, authentication of a user's identity allows access to remote servers, computers, applications, or other devices. For example, the user may authenticate the user's identity on the biometric authentication system to log into the user's computer at work. In some embodiments, the biometric authentication system causes a computer to be personalized for the user. For example, the biometric authentication system may wireless transfer a computer profile to a computer after authentication. The computer profile may personalize the computer (e.g., accounts, passwords, font size, etc.) for the user. In another embodiment, authentication of the user's identity allows physical access. For example, the mobile device may transfer a code to a keypad at a door or a vehicle to unlock the door. Safety deposit boxes, mailboxes, or lock boxes may be secured biometrically and opened only upon authentication of the user's identity.

In some embodiments, authentication further allows controlling of devices. For example, an automobile may be turned on when the user's identity is authenticated based on wirelessly connecting to an ignition control of a vehicle. Similarly, computers, home entertainment devices, or work machines may be operable only after authentication of a user's identity. In some embodiments, authentication through the biometric authentication system causes network-capable devices to be linked together. In an embodiment, the network-capable devices are the mobile device and a remote device. In another embodiment, however, the network-capable devices are two or more devices that do not include the associated mobile device.

In a still further embodiment, the biometric authentication system transfers identification information to third parties. For example, the system may transfer the user's identity information to a third party for identification purposes. In this example, the biometric authentication system can serve as a driver's license or DMV papers, passport, visa, immigration registration document, voter registration card, public transportation access device, access device for secure areas of buildings, etc. In some embodiments, the system also facilitates a transaction, such as a deposit from a third party, after transferring the user's identity information. For example, paychecks, refunds from purchases, tax refunds, child support payments, welfare payments, other government assistance, food stamps, prepaid cards, etc., may be transferred to the user after authentication of the user's identity to the third party.

In an embodiment, the system receives and or captures health data of the user. In some embodiments, the user's health data (e.g., prescription records, health insurance information, allergies, etc.) is stored in the biometrically-secured data storage. In an embodiment, the health care data can be transferred to a health care provider at the time of service. For example, the user may scan the user's fingerprint while at the emergency room so that the emergency care professionals may have immediate access to the user's health records. In an embodiment, the system also communicates with the insurance company to create a closed-loop for health care. In this embodiment, the system facilitates proper care and reimbursement by wirelessly communicating the associated records to both the health care provider and the insurance company. In this manner, the system reduces the chances of rejection of claims by authenticating the user's identity at the time of service.

In block 524, the application completes the request of the user. In some embodiments, the system locks the mobile device or user data after completing the request of the user. For example, the user may be required to authenticate the user's identity using a biometric scan in order to cause actions to occur. In another embodiment, the system does not lock the device or biometric authentication system until prompted to by the user, until the user again provides a biometric scan, or until a predetermined period of time expires.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

We claim:

1. A biometric authentication system for identifying a user, comprising:
a memory device;
a communication device; and
a processing device, operatively coupled to the memory device and the communication device, and configured to execute computer-readable program code to:
receive biometric information for a user;
store the biometric information for the user in the memory device;
compare the biometric information to a biometric scan; and
authenticate an identity of the user based on the comparison of the biometric information and the biometric scan.

2. The system of claim 1, wherein the memory device further comprises user data.

3. The system of claim 2, wherein the user data is encrypted based on the biometric information.

4. The system of claim 1, wherein the computer-readable program code is further configured to evaluate the biometric information and to determine whether the biometric information is diagnostic of the user.

5. The system of claim 1, wherein the computer-readable program code is further configured to transmit user data to a third party upon authentication of the user's identity.

6. The system of claim 1, wherein the computer-readable program code is configured to receive more than one set of biometric information, wherein each set of biometric information is assigned a unique characteristic.

7. The system of claim 6, wherein the unique characteristic is selected from the group consisting of a payment method, an application activation, and a device setting.

8. A biometric authentication computer program product for identifying a user, the computer program product comprising at least one non-transitory computer-readable medium having computer-readable program code portions embodied therein, the computer-readable program code portions comprising:
an executable portion configured for receiving biometric information for a user;
an executable portion configured for storing the biometric information for the user in a memory device;
an executable portion configured for comparing the biometric information to a biometric scan; and
an executable portion configured for authenticating an identity of the user based on the comparison of the biometric information and the biometric scan.

9. The computer program product of claim 8, further comprising:
an executable portion configured for storing user data in the memory device.

10. The computer program product of claim 9, wherein the user data is encrypted based on the biometric information.

11. The computer program product of claim 8, further comprising:
an executable portion configured to evaluate the biometric information; and
an executable portion configured to determine whether the biometric information is diagnostic of the user.

12. The computer program product of claim 8, wherein the biometric information is selected from the group consisting of a fingerprint scan, an iris scan, a pupil scan, a facial scan, and an EKG.

13. The computer program product of claim 8, further comprising an executable portion configured to collect health data of the user, wherein the health data of the user is stored in the memory device; and an executable portion configured to wirelessly transmit the health data based on authentication of the user's identity.

14. The computer program product of claim 8, further comprising and executable portion configured for transmitting account information to a transaction device based on authentication of the user's identity.

15. A biometric authentication method for identifying a user, the method comprising:
receiving biometric information for a user;
storing the biometric information for the user in a memory device;
comparing, via a computing device processor, the biometric information to a biometric scan; and
authenticating, via a computing device processor, an identity of the user based on the comparison of the biometric information and the biometric scan.

16. The method of claim 15, further comprising:
evaluating the biometric information to determine whether the biometric information is diagnostic of the user.

17. The method of claim 15, wherein the biometric information is compared to the biometric scan based on a statistical test of similarity, and wherein a minimum confidence level for similarity is required to authenticate the user's identity.

18. The method of claim 15, further comprising:
receiving user data from the user; and
encrypting the user data using the biometric information, wherein a metric is determined based on the biometric information and the metric is used to encrypt the user data.

19. The method of claim 18, further comprising:
transmitting the user data to a third party when the user's identity is authenticated.

20. The method of claim 19, wherein the transmission authenticates the user's identity to the third party.
